(19) United States
(12) Patent Application Publication
(10) Pub. No.: US 2011/0220682 A1
(43) Pub. Date: Sep. 15, 2011

(54) OPENABLE COSMETIC CASE OF DUAL STRUCTURE PROTECTING TUBE

(75) Inventor: Jun-Kuk Lim, Gyeonggi-do (KR)

(73) Assignee: TOLY KOREA, INC., Gyeonggi-do (KR)

(21) Appl. No.: 12/723,322

(22) Filed: Mar. 12, 2010

(51) Int. Cl. B67D 7/06; B65D 88/54

(52) U.S. Cl. 222/183; 222/321.1; 222/105

(57) ABSTRACT

The invention relates to an openable cosmetic case of a dual structure protecting a tube, and more particularly, to an openable cosmetic case of a dual structure protecting a tube wherein a tube-type inner case to which an airless pump is engaged is made of rigid material and is protected by an outer case that can be disassembled and assembled and the airless pump performs a pumping operation under state in which the pump is completely mounted in the outer case without being exposed to the outside, thereby improving structure and operation properties and protecting the tube of the inner case from the exterior shock, pressure and ultraviolet rays.

The cosmetic case has a dual structure in which a pair of outer cases that can be disassembled and assembled protect a tube-type inner case to which an airless pump is mounted. The inner case 100 is formed into a tube shape comprising a bag 110 that is made of flexible material and safely stores the contents and an injection pipe 120 that is heat-fused to an upper part of the bag 110 and has a connection piece 121 at an outer periphery. The outer cases 300, 300a are structured to be symmetrical to each other and have a mount space 310 in which the inner case is mounted and a vertical operation chamber 320 to which the airless pump is mounted, a lower part of the operation chamber 320 is formed with a connection recess 323 to which a connection piece 122 of the inner case is connected, one outer case 300 is formed with a nozzle guide hole 321 and the other outer case 300a is formed with a finger guide hole 322 having a semi-sphere shape. The airless pump 200 is mounted in the operation chamber 320 of the outer cases 300, 300a and performs a pumping operation with being supported to the operation chamber.

### BACKGROUND OF THE INVENTION

1. Field of the Invention

The invention relates to an openable cosmetic case of a dual structure protecting a tube, and more particularly, to an openable cosmetic case of a dual structure protecting a tube wherein a tube-type inner case to which an airless pump is engaged is made of rigid material and is protected by an outer case that can be disassembled and assembled and the airless pump performs a pumping operation under state in which the pump is completely mounted in the outer case without being exposed to the outside, thereby improving structure and operation properties and protecting the tube of the inner case from the exterior shock, pressure and ultraviolet rays.

2. Description of the Prior Art

The cosmetic case is to safely and efficiently store the cosmetics of liquid, gel or powders. Among the cosmetic cases, the cosmetics of a gel state such as sun cream are stored in a tube.

In other words, the tube storing the cosmetics of a gel state is made of flexible material such as aluminum, laminate, synthetic resin and the like, so that when a surface thereof is artificially pushed, the contents are discharged to an injection port by pushing force.

The tube-type cosmetic case can sealingly store a variety of detergents and medical supplies as well as various cream cosmetics. During the use of the case, it is possible to easily squeeze a proper amount of the cosmetics with the pressing force.

Although the above tube-type case can efficiently store a variety of contents, it has merits and demerits depending on the materials applied thereto.

In other words, when polyethylene resin is used, it has an advantage that an outward appearance thereof is restored even when the case is pressed. However, since an exit thereof is opened, the air is introduced into the case from the outside. Further, it is difficult to protect the contents from the ultraviolet rays.

In addition, since the tube-type case is structured to discharge the contents by the pressing force that presses the outer surface of the tube, it is difficult to always discharge a proper amount of the cosmetics.

Further, in order to solve the above problems, a case has been suggested in which a separate airless pump is mounted to an exit of a tube storing the contents.

Due to the airless pump the outside air is not introduced, so that the contents are safely stored for a long time. In addition, as the pump is operated, it is possible to accurately discharge a predetermined amount of the contents all the time. However, the outward appearance of the tube is changed.

In other words, since the tube is mage of flexible material, a volume of the tube is decreased as the contents are used, so that the outward appearance is changed. Thus, the outward appearance is not good and it is not easy to store and use the cosmetics.

Accordingly, there has been suggested a case comprising a tube-type inner case made of flexible material and an outer case formed at the outside of the inner case and composed of a rigid protection case.

According to the above structure, the airless pump is engaged to an upper part of the outer case, so that the pump and the upper part are exposed to the outside. Thus, the outward appearance is poor. In particular, the upward and downward movements are made under state that a push button or nozzle is exposed to the outside, so that the operation property is not good. Further, during the non-use of the case, a separate protection cover is necessarily required so as to protect them.

### SUMMARY OF THE INVENTION

Accordingly, the present invention has been made to solve the above problems occurring in the prior art.

An object of the invention is to provide an openable cosmetic case of a dual structure wherein inner and outer cases are provided, the inner case is formed into a tube shape so as to easily store the contents, to which an airless pump is mounted, and the outer case is formed into a rigid case that can be disassembled and assembled so as to safely protect the inner case, so that the used tube can be replaced for reuse, and the airless pump is moved upward and downward under state that it is mounted in the inner case without being exposed to the outside, so that outward appearance and an operation property are improved, the number of parts is decreased to reduce the manufacturing cost because a separate cover is not necessary and a variety of outward appearances can be designed.

Another object of the invention is to provide an openable cosmetic case of a dual structure wherein a structure of a tube corresponding to the inner case is improved to easily manufacture the cosmetic case and the contents can be safely stored for a long time.

In order to achieve the above objects, there is provided a cosmetic case storing the cosmetics of a gel state, which the case comprises an inner case made of a flexible tube and an outer case that protects the inner case and can be disassembled and assembled.

The inner case is made of flexible material such as laminate, synthetic resin and the like and has an injection port to which an airless pump is mounted. The outer case protecting the inner case is made of rigid synthetic resin and divided into two parts that can be disassembled and assembled. The tube-type inner case and the airless pump are inserted into the outer case without being exposed to the outside. Thus, the tube-type inner case, the airless pump, a nozzle and the like are safely protected from the exterior shock. In addition, the outer case can be easily disassembled and assembled and an overall outward appearance of the cosmetic case can be designed into various shapes.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view showing an overall cosmetic case to which the invention is applied;

FIG. 2 is an exploded perspective view of FIG. 1;

FIG. 3 is a front sectional view of FIG. 1;

FIG. 4 is a side sectional view of FIG. 1;

FIG. 5 shows one outer case of the invention;

FIG. 6 shows the other outer case of the invention;

FIG. 7 is a sectional view showing the outer cases shown in FIGS. 5 and 6 that are connected to each other; and

FIG. 8 is a sectional view showing a structure of an upper part of the invention.

### DETAILED DESCRIPTION OF THE PREFERRED EMBODIMENTS

Hereinafter, a preferred embodiment of the present invention will be described with reference to the accompanying drawings. In the following description of the present invention, a detailed description of known functions and configurations incorporated herein will be omitted when it may make the subject matter of the present invention rather unclear.

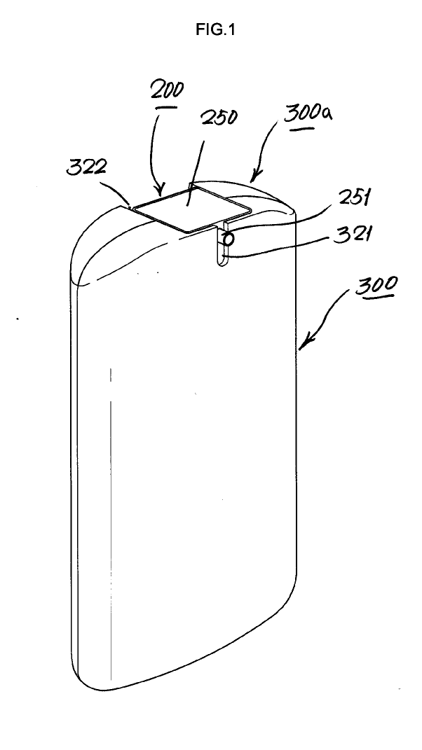

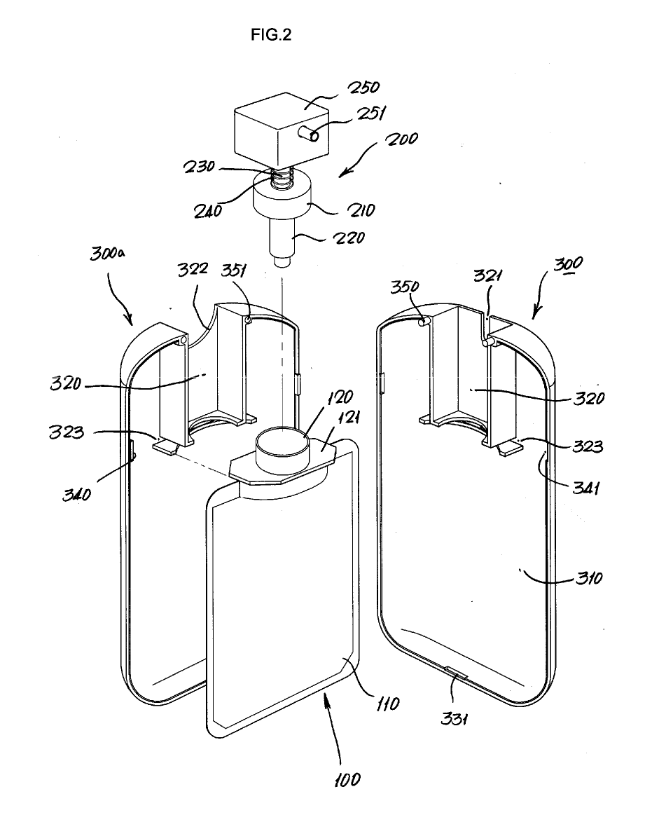

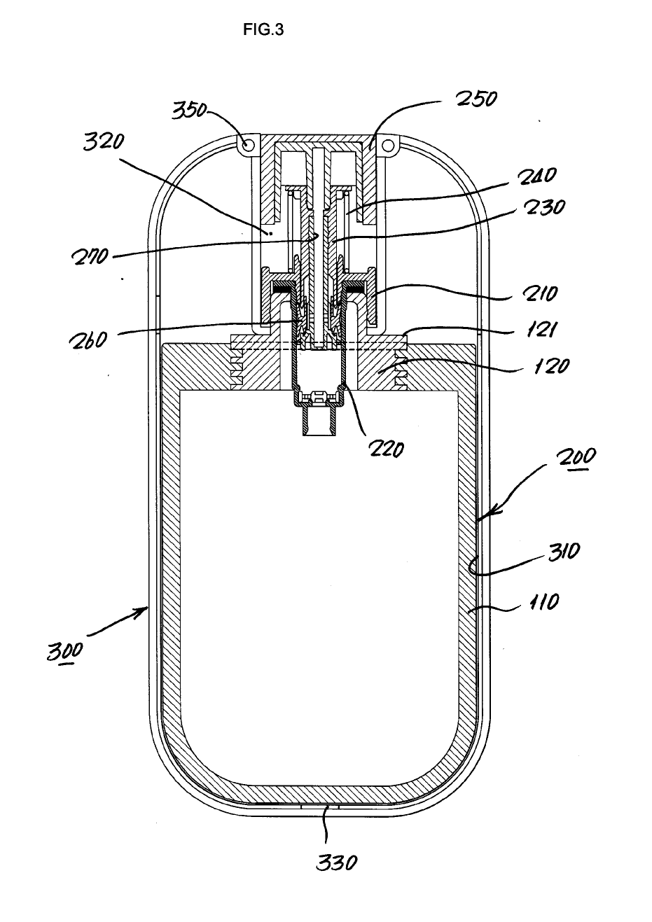

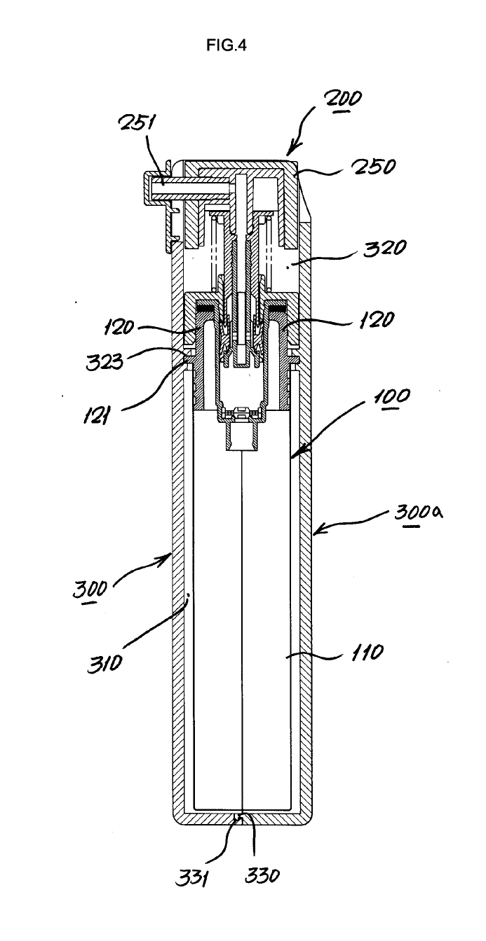

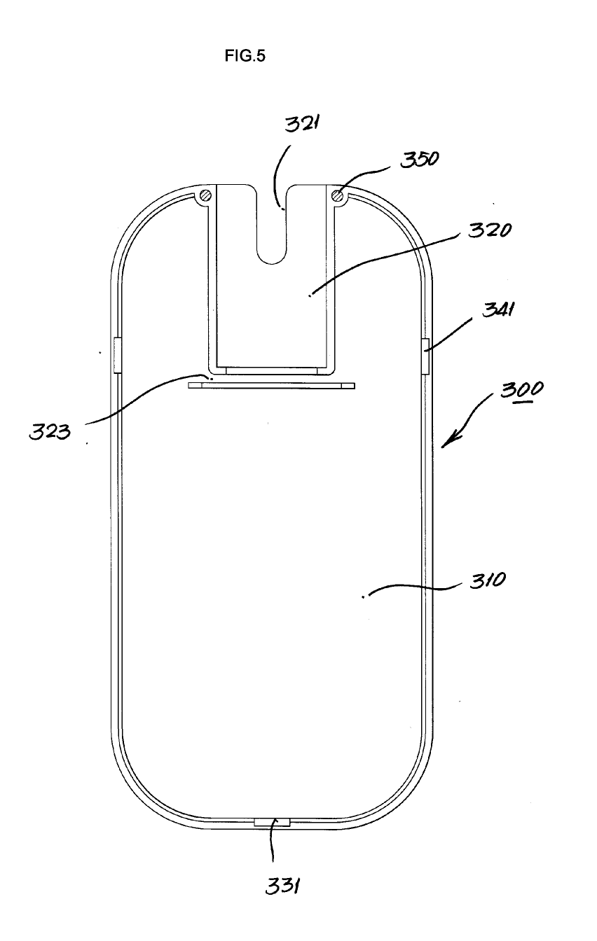

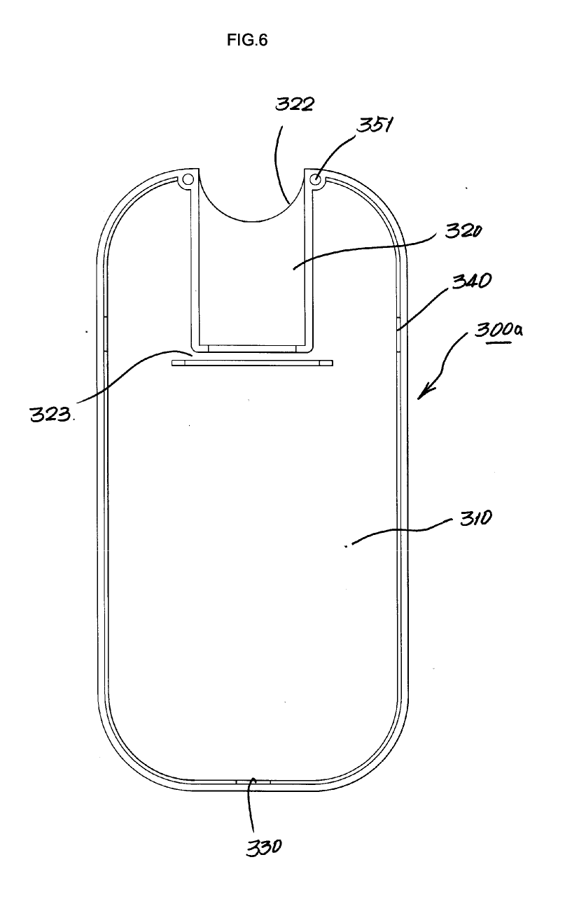

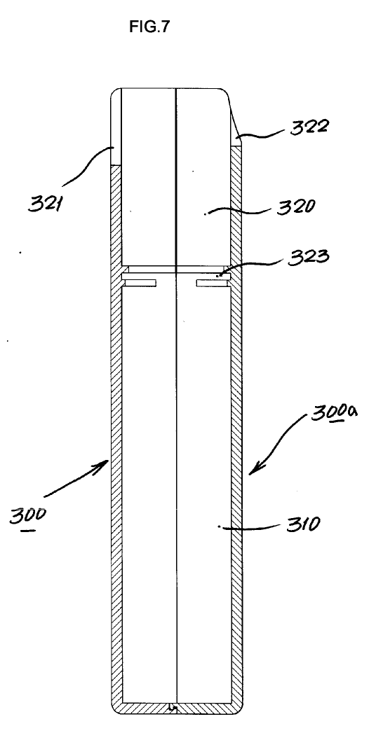

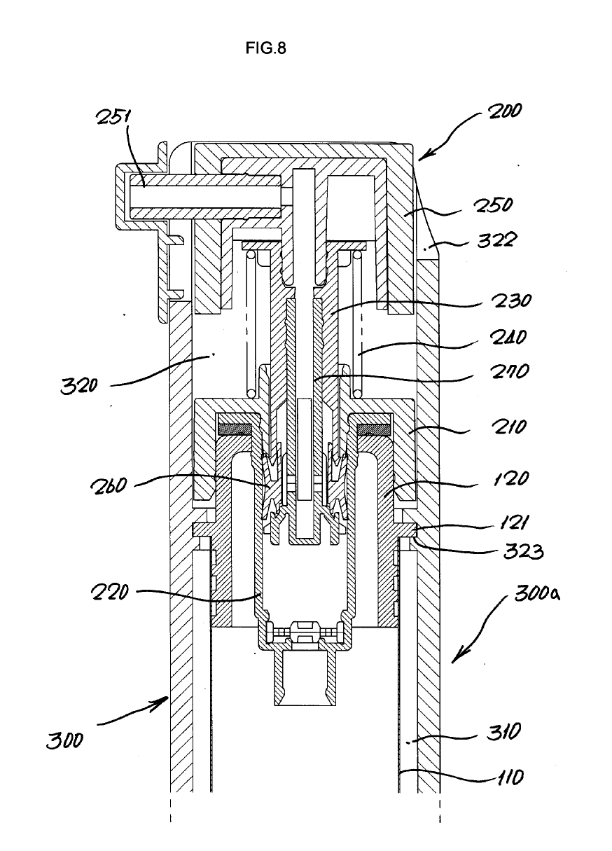

FIGS. 1 and 2 show an overall structure of the invention, FIGS. 3 and 4 are sectional views showing an inner structure of the invention and FIGS. 5 to 8 show detailed structures of the invention.

The cosmetic case of the invention comprises an inner case 100 that mainly stores a variety of cosmetics, particularly cosmetics of a gel state, an airless pump 200 that is mounted to an upper injection port of the inner case 100 and forcibly pumps the contents and outer cases 300, 300a that are engaged to surround the inner case 100, divided into two parts that can be disassembled and assembled, and made of rigid synthetic resin material.

The inner case 100 comprises a bag 110 that is made of flexible material such as laminate and synthetic resin so as to easily store the contents of a gel state and enables the contents to be safely stored from the ultraviolet rays and air, and an injection pipe 120 that is integrally formed at an upper part of the bag 110, enables the contents to be injected and discharged and is made of rigid synthetic resin.

The bag 110 is made by connecting two thin plate films so as to contact each other and joining edges thereof with heat fusion. The injection pipe 120 made of rigid synthetic resin is also connected to a center of the bag by the heat fusion.

The injection pipe 120 is provided to inject the contents into the bag 110 or to discharge the contents for use. The injection pipe has an injection port into which a pump is inserted and through which the contents go in and out, at its outer periphery a connection piece 121 that is protruded for connection with the outer case and protrusions of multi layers formed at its lower part, so that the injection pipe can be easily heat-fused with the bag 110.

Like this, the inner case 100 comprises the bag 110 of flexible material and the rigid injection pipe 120 that is integrally connected to the upper part of the bag, so that it can safely store a variety of contents.

In addition, the airless pump 200 that is connected to the inner case 100 comprises a nozzle cap 210 that is engaged to the injection pipe 120 of the inner case 100. To a lower part of the nozzle cap 210 is engaged a cylinder 220 that is inserted into the injection pipe 120 and to an upper part of the nozzle cap is mounted an operation button 250 that is elastically supported by a guide pipe 230 and a spring 240. A nozzle 251 communicating with the guide pipe 230 is horizontally mounted to one side of the operation button 250.

In addition, a valve 260 and an operation pipe 270 are mounted in the cylinder 220, which are connected to the guide pipe 230 and enable a discharge passage to be opened while compressing the inside of the cylinder as the guide pipe is moved upward and downward.

The outer case is divided into two parts 300, 300a that are symmetrical to each other and are connected to protect the inner case. The outer cases have a mount space 310 so that the inner case can be mounted therein and an operation chamber 320 at their upper parts to which the airless pump 200 is mounted and operated.

The operation chamber 320 has a structure that enables the upper and lower parts to communicate with each other. One outer case 300 is formed with a nozzle guide hole 321 upward opened through which the nozzle 251 of the pump is moved upward and downward. The other outer case 300a is formed with a finger guide hole 322 upward opened that guides a finger when a user pushes the operation button 250 with the finger.

In addition, the operation chamber 320 is formed at its lower part with a connection recess 323 into which a connection piece 122 of the inner case 100 is inserted and connected. The connection recess is a space that is generated between a protrusion piece formed at a position close to a lower end of the operation chamber 320 and the connection piece 122 formed at the injection pipe 120 of the inner case 100 is inserted and fixed in the recess.

Additionally, the outer cases 300, 300a are connected and disconnected to each other, so that they have at centers of the lower ends thereof a lower connection protrusion 330 and a lower connection recess 331, respectively, which are connected to each other. Further, both sides thereof are also formed with a side connection protrusion 340 and a side connection recess 341 and both upper sides of the operation chamber 320 are formed with a connection pin 350 and a connection hole 351, respectively.

According to the invention structured as described above, the airless pump 200 is inserted and assembled in the injection port under state that the cosmetics are filled in the bag 110 through the injection port of the tube-type inner case 100.

At this time, the nozzle cap 210 of the pump is interference-fitted to the injection port of the inner case 100, thereby sealing the inner case. In addition, the lower operation pipe 270 of the pump is inserted into the inner case and maintains an operation standby state.

Under such state, the inner case 100 is inserted into the mount space 310 in the one outer case 300 and the connection piece 122 formed at the injection port 120 is fitted to the connection recess 323 formed at the lower part of the operation chamber 320 of the outer case 100.

The connection piece 122 is outwardly protruded along the outer periphery of the injection pipe 120. Thus, when the connection piece is connected to the connection recess 323 of the outer case 100, it is fixed without a play and the bag 110 rests in the mount space 310.

Additionally, the nozzle cap 210 and the operation button 250 of the airless pump 200 connected to the inner case 100 are inserted and fixed without a play in the operation chamber 320 of the outer case 300. At this time, the nozzle 251 of the operation button 250 is positioned at the nozzle guide hole 321 of the outer case 300.

Then, when the other outer case 300a is interference-fitted to the one outer case 300 with facing each other, the lower connection protrusion 330 and the lower connection recess 331 are connected, the side connection protrusion 340 and the side connection recess 341 are connected and the upper connection pin 350 and the connection hole 351 are connected, so that the outer cases 300, 300a are connected in a manner of surrounding the inner case 100 and the airless pump 200.

In other words, the connection force of the lower connection protrusion 330 and the lower connection recess 331 of the outer cases 300, 300a prevents the outer cases 300, 300a from being vertically deviated. Meantime, the side connection protrusion 340 and the side connection recess 341 are to prevent the outer cases from being deviated sideways. In addition, the connection force of the connection piece 350 and the connection hole 351 is to prevent movement due to the operation of the airless pump 200.

Thus, when the connection of the outer cases 300, 300a is completed as described above, the inner case 100 is inserted in the mount space of the outer cases and the airless pump 200 is mounted in the operation chamber 320. At this time, the nozzle 251 of the airless pump 200 is positioned in the nozzle guide hole 321 and only the top face of the operation button 250 is exposed to the outside.

Under such state, when a user intends to use the cosmetics filled in the inner case, the user pushes the operation button 250 as shown in the drawings. Thereby, the operation button 250 moves the guide pipe 230 downward while compressing the spring 240, so that the valve 260 and the operation pipe 270 compress the inside of the cylinder 220. As a result, the contents in the cylinder are discharged through the nozzle 251.

To the contrary, when the pushed operation button 250 is released, the operation button 250 is returned to its original position by the restoring force of the spring 240, so that the guide pipe 230, the valve 260 and the operation pipe 270 are also returned to their original positions, thereby expanding the inside of the cylinder 220. Thereby, the contents in the inner case 100 are introduced into the cylinder and stands by for next operation.

Accordingly, by repeating the above operations, it is possible to efficiently use the contents stored in the inner case 100. After completely using the contents in the inner case 100, by disassembling the outer cases 300, 300a in a reverse sequence, it is possible to replace the inner case 100. In particular, according to the invention, the inner case 100 and the airless pump 200 are mounted in the outer cases 300, 300a, so that the pumping operation is made in the outer cases and the operation property is thus improved. Additionally, it is possible to protect the related parts and to realize a simple outward appearance.

As described above, according to the invention, the cosmetic case is formed into a dual structure of the tube-type inner case made of flexible material such as laminate, synthetic resin and the like, the airless pump engaged to an upper part of the inner case, and the outer case made of rigid synthetic resin and composed of a pair of protection cases that can be disassembled and assembled. Thus, it is possible to efficiently and safely store various medical supplies and detergents as well as various cosmetics.

In particular, the tube-type inner case can be made of peculiar material such as laminate and synthetic resin depending on the contents to be stored, so that the contents can be stored more safely.

In addition, according to the invention, the tube-type inner case and the airless pump are completely mounted in the outer case, so that the airless pump, the nozzle and the like are perfectly protected from the exterior shock because they are not exposed to the outside. Further, the operation property relating to the push operation is improved.

Furthermore, since the inner case and the airless pump are mounted in the outer case, it is possible arbitrarily manufacture the outward appearance of the outer case. Thus, it is possible to provide a high-grade article and to design various shapes such as animals and plants on the cosmetic case.

While the invention has been shown and described with reference to certain preferred embodiments thereof, it will be understood by those skilled in the art that various changes in form and details may be made thereto without departing from the spirit and scope of the invention as defined by the appended claims.

What is claimed is:

1. A cosmetic case of a dual structure in which a pair of outer cases that can be disassembled and assembled protect a tube-type inner case to which an airless pump is mounted,
wherein the inner case is formed into a tube shape comprising a bag that is made of flexible material and safely stores the contents and an injection pipe that is heat-fused to an upper part of the bag and has a connection piece at an outer periphery,
wherein the outer cases are structured to be symmetrical to each other and have a mount space in which the inner case is mounted and a vertical operation chamber to which the airless pump is mounted, a lower part of the operation chamber is formed with a connection recess to which a connection piece of the inner case is connected, one outer case is formed with a nozzle guide hole and the other outer case is formed with a finger guide hole having a semi-sphere shape, and
wherein the airless pump is mounted in the operation chamber of the outer cases and performs a pumping operation with being supported to the operation chamber.

2. The cosmetic case according to claim 1, wherein the outer cases have at their center a lower connection protrusion and a lower connection recess, respectively, and at both sides thereof a side connection protrusion and a side connection recess, respectively, and both sides of the operation chamber are formed with a connection pin and a connection hole, respectively, so that the outer cases can be disassembled and assembled.
